(19) United States
(12) Patent Application Publication
(10) Pub. No.: US 2019/0306628 A1
(43) Pub. Date: Oct. 3, 2019

(54) AIR COOLING APPARATUS

(71) Applicant: BAE Systems Controls Inc., Endicott, NY (US)

(72) Inventors: Stephen A. McKeown, Endicott, NY (US); Rafael D. Garcia, Oneonta, NY (US); Joshua P. Stewart, Vestal, NY (US)

(73) Assignee: BAE Systems Controls Inc., Endicott, NY (US)

(21) Appl. No.: 15/940,110

(22) Filed: Mar. 29, 2018

(51) Int. Cl. H04R 9/02; H04R 1/28

(52) U.S. Cl. CPC H04R 9/022; H04R 1/2807

(57) ABSTRACT

Apparatus for air cooling includes an acoustic transducer secured to a body. The body has a first wall including a first opening and the acoustic transducer forms a second wall facing the first wall. A chamber within the body is defined between the acoustic transducer and the first wall and is in fluid communication with the chamber. The first wall is interposed between a third wall and the chamber. The third wall includes a second opening facing the first opening. An inflow path is disposed between the first wall and the third wall. The inflow path includes outer ends communicating with the outside air and inner ends connected to the first and second openings. The acoustic transducer includes a diaphragm that vibrates in response to a drive system causing outside air incoming through the inflow path into the chamber to flow from the chamber through the first and second openings.

### FIELD OF DISCLOSURE

The present disclosure relates to an apparatus for delivering air cooling and more particularly to forced-air cooling without a rotating fan.

### BACKGROUND

Today's electronic devices require thermal cooling solutions that are increasingly smaller, lightweight, have low power consumption, and reduce heat generation. Thus, thermal cooling solutions for applications that have limited space with restricted power budgets must manage heat generation effectively, be energy efficient, and be durable for a long operating life.

Current solutions, such as the piezoelectric micro-blower disclosed in U.S. Pat. No. 8,678,787 are known to have durability problems for applications such as harsh thermal and vibration environments. For example, durability is an important design factor for military and aerospace equipment.

### BRIEF SUMMARY

The disclosed apparatus provides air cooling without a rotating fan that is lightweight, has low power consumption and is durable for a long operating life.

In one aspect of the present disclosure, an acoustic transducer is secured to a body. The body has a first wall including a first opening. The acoustic transducer forms a second wall of the body facing the first wall. A chamber within the body is defined between the acoustic transducer and the first wall. The first opening is in fluid communication with the chamber. A third wall is spaced from the first wall such that the first wall is interposed between the third wall and the chamber. The third wall includes a second opening facing the first opening. An inflow path is disposed between the first wall and the third wall. The inflow path includes outer ends communicating with the outside of the air cooling apparatus and inner ends connected to the first opening and the second opening. The acoustic transducer includes a diaphragm configured to vibrate in response to a drive system causing outside air to flow through the inflow path into the chamber to flow from the chamber through the first and second openings. In one embodiment, the acoustic transducer is one of a type of loudspeaker.

In another embodiment, the volume of the chamber, the axial length of the first opening and surface area of the first opening are configured to form a Helmholtz resonator.

### BRIEF DESCRIPTION OF THE DRAWINGS

The details of the present disclosure, both as to its structure and operation, can be understood by referring to the accompanying drawings, in which like reference numbers and designations refer to like elements.

FIG. 1 is cross-sectional schematic diagram of one embodiment of the cooling apparatus of the present disclosure.

FIG. 2 is an isometric diagram of one embodiment of the cooling apparatus of the present disclosure.

FIG. 3 is exploded view of one embodiment of the cooling apparatus of the present disclosure.

FIG. 4A is a bottom plan view of one embodiment of the cooling apparatus of the present disclosure.

FIG. 4B is cross-sectional diagram taken along lines 4-4 of FIG. 4A of one embodiment of the cooling apparatus of the present disclosure.

FIG. 5A is a side elevational view of one embodiment of the cooling apparatus of the present disclosure.

FIG. 5B is cross-sectional diagram taken along lines 5-5 of FIG. 5A of one embodiment of the cooling apparatus of the present disclosure.

FIG. 6 is exploded view of one embodiment of the cooling apparatus of the present disclosure having a spring-mass drive system.

### DETAILED DESCRIPTION

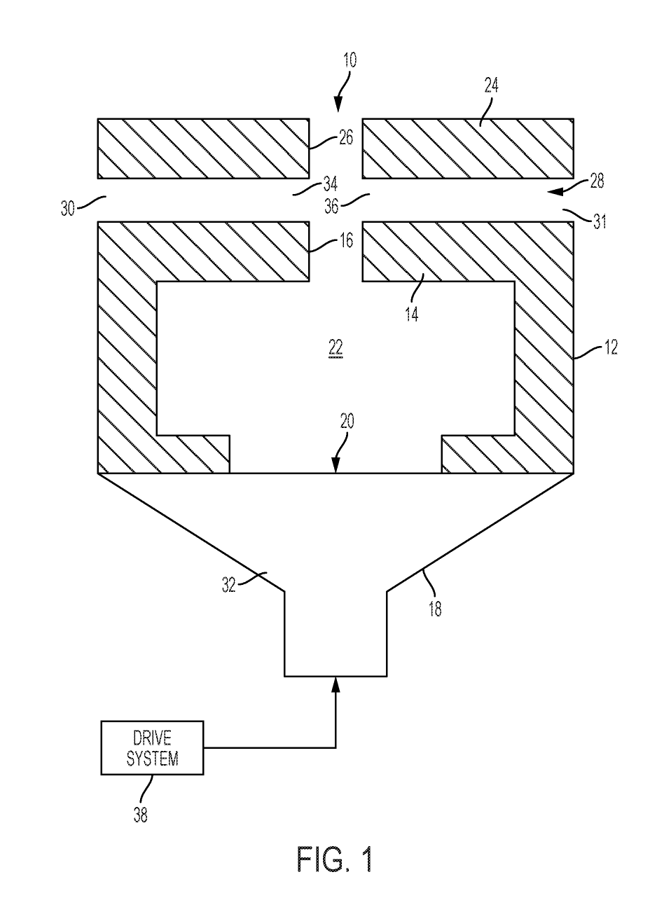

With reference to the figures, FIG. 1 is a schematic cross section of one embodiment of the air cooling apparatus 10 of the present disclosure. The air cooling apparatus 10 includes a body 12 having a first wall 14 including a first opening 16. An acoustic transducer 18 is secured to the body 12 at a perimeter thereof forming a second wall 20 of the body 12 facing the first wall 14. A chamber 22 within the body 12 is defined between the acoustic transducer 18 and the first wall 14. The first opening 16 is in fluid communication with the chamber 22. A third wall 24 is spaced from the first wall 14 such that the first wall 14 is interposed between the third wall 24 and the chamber 22. The third wall 24 includes a second opening 26 facing the first opening 16 and is in fluid communication with the outside of the air cooling apparatus 10. An inflow path 28 is disposed between the first wall 14 and the third wall 24. The inflow path 28 includes outer ends 30, 31 communicating with the outside of the air cooling apparatus 10 and inner ends 34, 36 connected to the first opening 16 and the second opening 26. In the cross-section of FIG. 1, a single inflow path 28 is shown with two inlets 30 and 31. It should be understood that the body 12 may have a plurality of inflow paths 28, each in fluid communication with openings 16 and 26.

The acoustic transducer 18 includes a diaphragm 32 configured to vibrate in response to a drive system 38 causing outside air incoming through the inflow path 28 into the chamber 22 to flow from the chamber 22 through the first and second openings 16 and 26. In one embodiment, the air flow exiting second opening 26 provides forced-air for cooling without a rotating fan.

In operation, when a voltage is applied to the acoustic transducer 18, in a first quarter cycle, the diaphragm 32 is bent downward, the distance between the first opening 16 and the diaphragm 32 increases, and fluid is drawn from the outside through inflow path 28, through the first opening 16 and into the chamber 22. In the next quarter cycle, the diaphragm 32 returns to the original flat state. Thus, the distance between the first opening 16 and the diaphragm 32 decreases and the fluid is forced out and flows upward through the openings 16 and 26. Since the fluid flows upward while pulling in the fluid in the inflow path 28, a high flow rate can be obtained at the outlet of the second opening 26. In the next quarter cycle, the diaphragm 32 is bent upward, the distance between the first opening 16 and the diaphragm 32 decreases, and the fluid in the chamber 22 is forced out at high speed and flows upward through the openings 16 and 26. Since this high-speed flow flows upward while pulling in the fluid in the inflow path 28, a high flow rate can be obtained at the outlet of the second opening 26. In the next quarter cycle, the diaphragm 32 returns to the flat state. Thus, the distance between the first opening 16 and the diaphragm 32 increases, and the fluid passes through the first opening 16 and is drawn into the chamber 22 to some extent. However, inertia causes the fluid in the inflow path 28 to keep flowing toward the center of the body 12 and in the direction along which the fluid is forced out of the chamber. The operations are repeated cyclically according to the frequency of the drive system.

By causing the diaphragm 32 to bend and vibrate at a high frequency, the next flow can be generated at the openings 16 and 26 before the inertia of the fluid flowing through the inflow path 28 ends. Thus, a flow of fluid toward the center of the body 12 can be constantly generated in the inflow path 28. In other words, when the diaphragm 32 is displaced in the direction along which the distance between the first opening 16 and the diaphragm 32 increases, the fluid in the inflow path 28 is drawn through the first opening 16 into the chamber 22. Similarly, when the diaphragm 32 is displaced in the direction along which the distance between the first opening 16 and the diaphragm 32 decreases, the fluid in the inflow path 28 outside the chamber 22 is drawn into a high-speed flow forced out of the chamber 22 through the second opening 26, and is forced out together with the high-speed flow.

Thus, in response to the displacement of the diaphragm 32, the fluid in the inflow path 28 can be drawn into the openings 16 and 26 by the fluid flowing through the openings 16 and 26 at high speed. That is, when the diaphragm 32 is displaced not only in the downward direction but also in the upward direction, the fluid can be drawn from the inflow path 28 into the openings 16 and 26. Since the fluid drawn from the inflow path 28 and the fluid forced out of the chamber 22 are joined together and discharged from the second opening 26, the amount of discharge flow can be greater than or equal to the volume of the chamber 22 changed by displacement of the diaphragm 32. Since the inflow path 28 is connected to the space between the openings 16 and 26 and is not directly connected to the chamber 22, the inflow path 28 is unaffected by changes in pressure in the chamber 22.

In one embodiment, the acoustic transducer 18 may be a loudspeaker having a diaphragm that is configured to vibrate in response to a drive system. The loudspeaker may be one of various types, such as moving coil, horn or electrostatic. The loudspeaker includes a diaphragm that is configured to vibrate in response to an electrical drive system. The loudspeaker may be a type that operates in particular frequency range, such a sub-woofer, woofer, a mid-range squawker or a high frequency tweeter. In another aspect, the acoustic transducer includes a diaphragm configured to vibrate in response a mechanical drive system.

One major limitation of piezoelectric powered blowers is thermal environment. Due to the construction of the multi-layer ceramic piezoelectric element, they work in a targeted temperature range (usually 0-70° C.). They can be manufactured for higher temperature ranges, but then will not work well at lower temperatures. A clear advantage of the use of an acoustic transducer of the present disclosure is that it could work over a large range of temperatures (MIL temp range). In some applications, parts of the air cooling apparatus, such as the sound cone, can be ruggedized.

In another embodiment, the volume of the chamber 22, the axial length of the first opening 16 and surface area of the first opening 16 are configured to form a Helmholtz resonator. In one aspect, the Helmholtz resonator is configured to resonate the drive frequency of the acoustic transducer 18.

The Helmholtz resonator is created by the volume of air in and near the first opening 16 vibrating from the ‘springiness’ of the air inside the chamber 22. When the air inside the chamber is compressed, its pressure increases and it tends to expand back to its original volume. When the air in the opening of a Helmholtz resonator is disturbed, it bounces like a mass on a spring in simple harmonic motion, creating sound. The frequency of the sound created is equal to that of the air's vibration. This frequency is determined by a formula,

$$f = \frac{c}{2 π} \sqrt{\frac{S}{VL}}$$

where f is the frequency, c is the speed of sound in air, S is the surface area of the first opening 16, V is the volume of air in the chamber 22 and L is the length of the first opening 16. In another aspect, the value of L could be the full length from the inner face of opening 16 to the outer face of second opening 26. In another aspect, the value of L could be in between the length of the first opening 16 and the full length from the inner face of opening 16 to the outer face of second opening 26. In one example case, the resonant frequency using the formula was 150 Hz using the length of port 16 and 110 Hz using the full length of the port. Finite-element analysis calculated a resonance of 117 Hz. In this example the full length is closer to the finite-element result.

In one embodiment, the frequency of the input to the loudspeaker 18 can be adjusted to resonate the chamber 22. In addition, the phase of the drive current can then be detected to “lock on” to the resonant frequency using the appropriate circuitry. The dimensions of the resonator can be adjusted to maximize the output but minimize drive power.

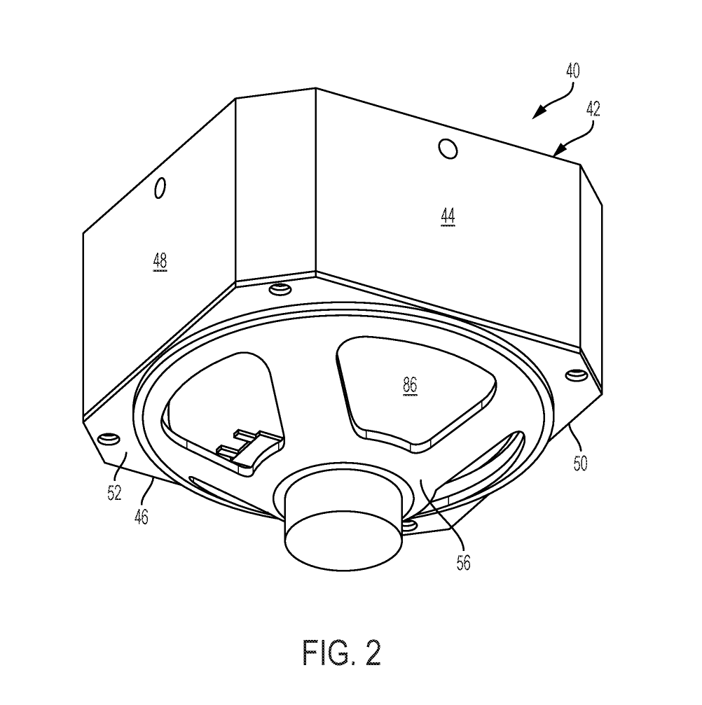

Referring now to FIGS. 2-5, one embodiment of an air cooling apparatus 40 of the present disclosure includes a cavity body 42 having a pair of opposing sides 44, 46 and a pair of opposing sides 48, 50. The body 42 includes a first bottom wall portion 52 and an opening 54. A loudspeaker 56 is attached to the first bottom wall portion 52 covering the opening 54 to form a second bottom wall portion of the apparatus 40. In one aspect, a gasket 58 forms a seal between the loudspeaker 56 and the body 42. The loudspeaker 56 may include a flange portion 60 with screw holes that align with screw holes 64 in gasket 58 and screw holes 66 on first bottom wall portion 52 for one means for securing the loudspeaker 56 to the body 42.

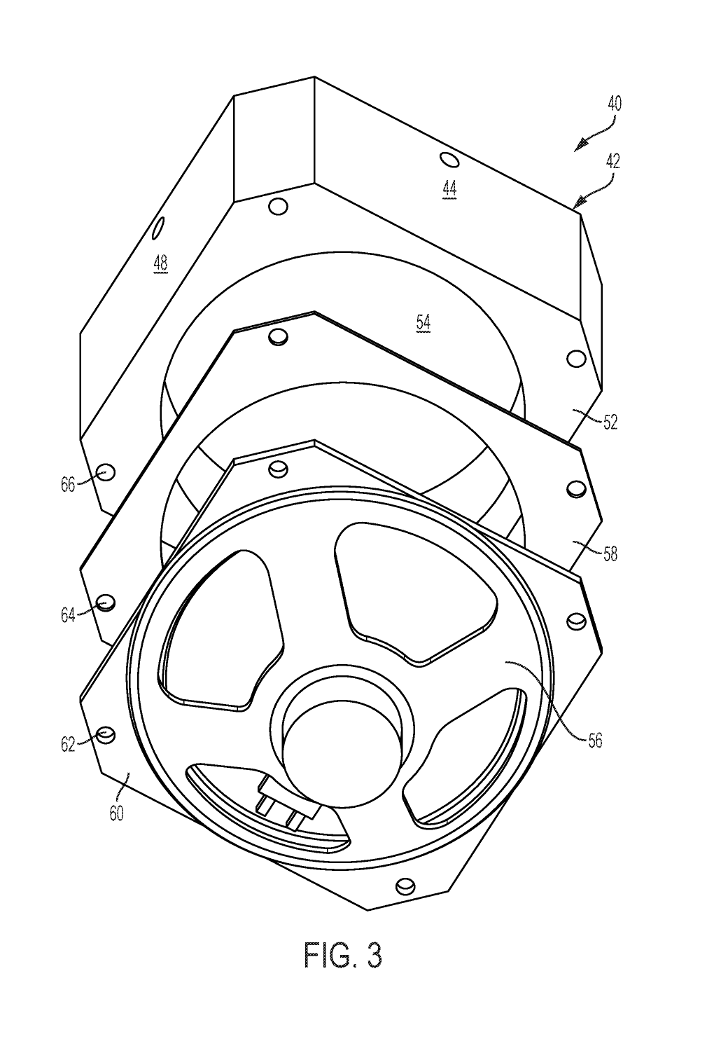

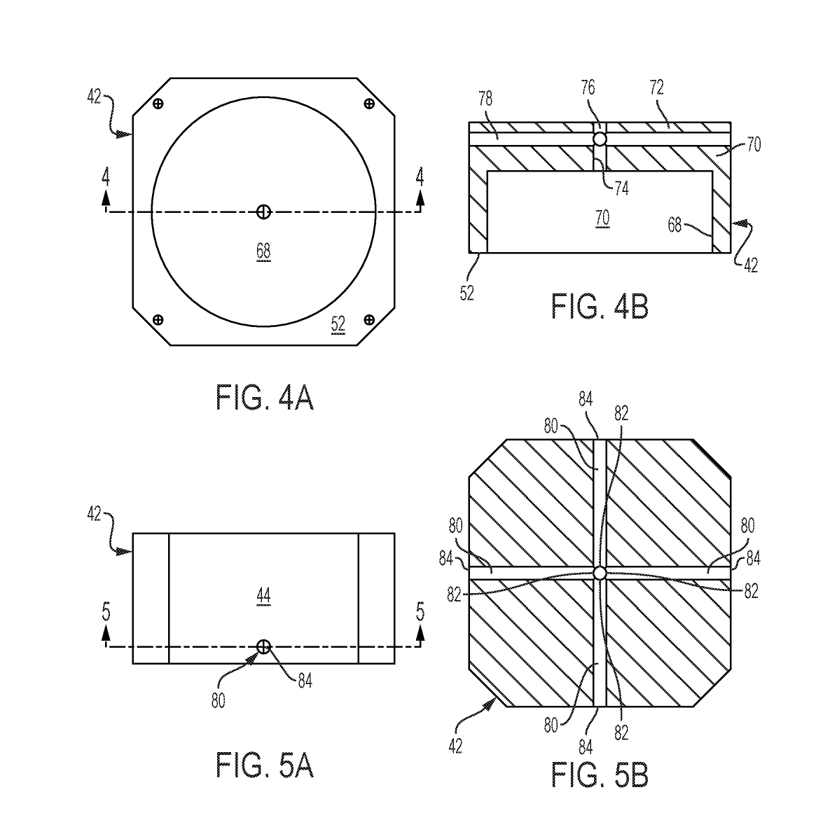

As shown in FIG. 4B, the body 42 includes a cavity 68 extending from the first bottom wall portion 52 to a first transverse wall 70. FIG. 4A is a plan view of the bottom of body 42 and FIG. 4B is a cross-section of the body 42 taken along lines 4-4 in FIG. 4A. The body 42 includes a second transverse wall 72 formed above first transverse wall 70. First transverse wall 70 includes opening 74 and second transverse wall 72 includes opening 76. An inflow path 78 is disposed between the first transverse wall 70 and the second transverse wall 72.

The inflow path 78 is shown in detail in FIG. 5A and FIG. 5B. FIG. 5B is a side elevation view of wall 44 of body 42 and FIG. 5B is a cross-section taken along lines 5-5 of FIG. 5A. As shown in FIG. 5B, the inflow path 78 includes four branches 80. The inner ends 82 of each branch 80 are in fluid communication with first and second openings 74 and 76. The outer ends 84 of each branch 80 are in fluid communication with the outside air. A chamber 70 is formed by the diaphragm 86 of the loudspeaker 56 and the cavity 68. In one aspect, the chamber 70 acts a spring part of a Helmholtz resonator. The openings 74 and 76 form an exit port portion of the Helmholtz resonator. A drive system vibrates the diaphragm of the loudspeaker which causes air to be pulled into the unit through the inflow path branches 80. Based on the Bernoulli principle, described above, in which pressure is reduced due to velocity of air, air is radially drawn into the body through the inflow branches 80 and then exited through the exit ports 74, 76 to provide an air flow for cooling.

In one aspect, the loudspeaker is a conventional loudspeaker configured to vibrate in response to an electrical drive system at a desired frequency.

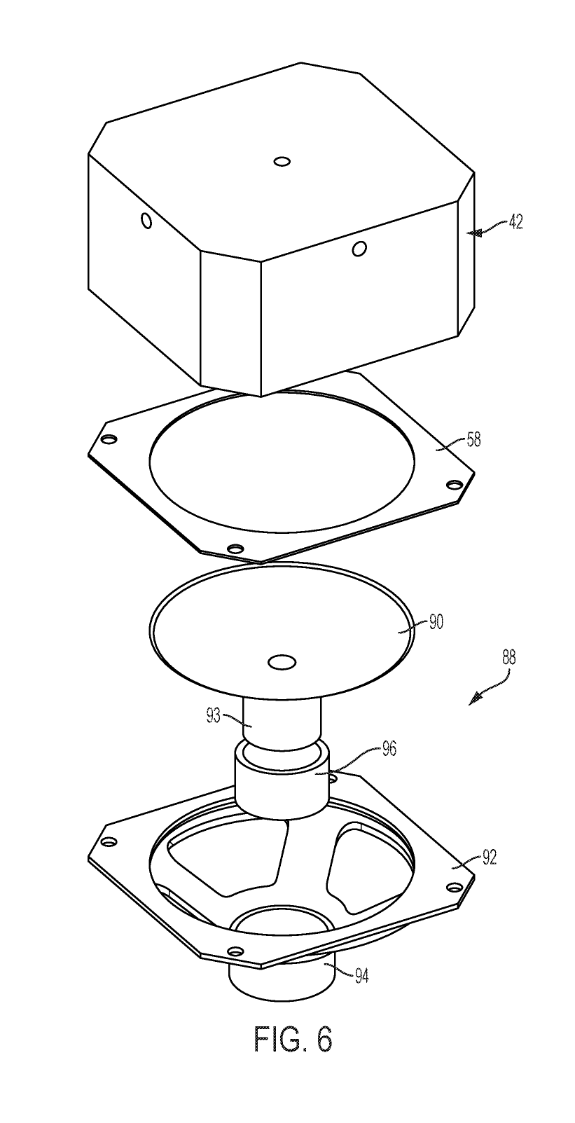

In another aspect, a spring-mass system may be used to drive the loudspeaker suspension system without an electrical input. In one aspect, the vibration of the equipment in which the cooling apparatus is installed drives the spring-mass system. As shown in FIG. 6, the loudspeaker 88 has a diaphragm 90 and frame 92. The spring of the spring-mass system is provided by the natural “springiness” of the speaker diaphragm 90. A weight 93 is attached to the center of the diaphragm 90. The speaker frame 92 includes a feature 94 to hold a sleeve 96 that allows the weight 93 to move in one direction only. The direction of travel would be oriented with the primary vibration direction of the system in which is installed. For example in a turbine aircraft engine application the dominant vibration direction is expected to be radial. The sleeve may be made of PTFE or other similar material.

The mass m of the weight 93 is attached to the diaphragm 90 having a spring constant k, which will exhibit simple harmonic motion caused by vibration of the equipment. The inertia of the mass would cause the mass to stay somewhat stationary as the system moved. With an excitation frequency due to system vibration close the resonant frequency of the spring/mass and/or Helmholtz resonator vibration response in excess of the input vibration will be realized. Both the Helmholtz resonator and the spring mass would be tuned to the dominant input frequency.

The equation for describing the resonant frequency is:

$$f = \frac{1}{2 π} \cdot \sqrt{\frac{k}{m}}$$

In one aspect, the specific mass value may be selected to provide a resonant frequency that matches the excitation frequency in the system for causing the apparatus to act as a Helmholtz resonator.

In one aspect, the air cooling apparatus of the present disclosure is used for supplying a certain amount of air to a small electronic machine or a part. Several non-limiting examples include air cooling of portable electronic devices such as laptop computers, PDAs, and mobile phones, especially for fuel cells used in such portable electronic devices. In one aspect, the cooling apparatus adapted for small scale cooling may have a body diameter of less than 12 inches. In one example, it is expected that a configuration with a 3.5-inch diameter cavity resonating at 117 Hz would provide a flow rate in excess of 3 cubic feet per minute as the drive frequency approaches resonance with 1-Watt RMS of drive power. While this may be somewhat less efficient than a conventional rotating fan but the issues of bearing wear, particularly at high temperature, are avoided. In another aspect, the cooling apparatus may be expanded to large scale (such as a 12-inch or greater diameter) with a low frequency input for large-scale cooling.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. An air cooling apparatus comprising:
a body having a first wall including a first opening;
a loudspeaker secured to the body at a perimeter thereof forming a second wall of the body facing the first wall;
a chamber within the body defined between the loudspeaker and the first wall, the first opening being in fluid communication with the chamber, the volume of the chamber, the axial length of the first opening and the surface area of the first opening being configured to form a Helmholtz resonator configured to resonate the drive frequency of the loudspeaker.
a third wall spaced from the first wall such that the first wall is interposed between the third wall and the chamber, the third wall including a second opening facing the first opening; and
an inflow path disposed between the first wall and the third wall, the inflow path including outer ends communicating with the outside of the air cooling apparatus and inner ends connected to the first opening and the second opening.

2. (canceled)

3. The air cooling apparatus of claim 1, wherein the loudspeaker includes a diaphragm configured to vibrate in response to an electrical drive system.

4. The air cooling apparatus of claim 1, wherein the loudspeaker includes a diaphragm configured to vibrate in response a mechanical drive system.

5. (canceled)

6. (canceled)

7. The air cooling apparatus of claim 1, wherein the outer ends of the inflow path communicate radially with the outside of the air cooling apparatus.

8. The air cooling apparatus of claim 4, wherein the mechanical drive system comprises a spring-mass system.

9. The air cooling apparatus of claim 4, wherein the mechanical drive system is driven by the vibration of an apparatus to which the body is attached.

10. The air cooling apparatus of claim 8, wherein the spring-mass system includes a weight attached to a diaphragm of the acoustic transducer.

11. The air cooling apparatus of claim 1, wherein the loudspeaker is cone-shaped.
